(19) United States
(12) Patent Application Publication
(10) Pub. No.: US 2007/0080536 A1
(43) Pub. Date: Apr. 12, 2007

(54) Dissimilar metal tube assembly and method of assembling the same

(75) Inventor: Hong-ik Park, Gwangju (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/543,027

(22) Filed: Oct. 5, 2006

(30) Foreign Application Priority Data
Oct. 10, 2005 (KR) 10-2005-0095158

(51) Int. Cl. F16L 25/00; F16L 21/00

(52) U.S. Cl. 285/329; 285/397

(57) ABSTRACT

A dissimilar metal tube assembly and a method of assembling the same. The dissimilar metal tube assembly comprises a first metal tube; a second metal tube different in melting point from the first metal tube; and a tubular sleeve connecting the first metal tube and the second metal tube to be contacted and coupled with each other while opposite sides of the sleeve are coupled with the first metal tube and the second metal tube, respectively.

### CROSS-REFERENCE TO RELATED APPLICATIONS

This application claims the benefit of Korean Patent Application No. 10-2005-0095158, filed on Oct. 10, 2005, in the Korean Intellectual Property Office, the disclosure of which is incorporated herein by reference.

### BACKGROUND OF THE INVENTION

1. Field of the Invention

The present invention relates to a dissimilar metal tube assembly and a method of assembling the same, and more particularly, to a dissimilar metal tube assembly and a method of assembling the same, which is improved in structure.

2. Description of the Related Art

In general, a dissimilar metal tube assembly is used to connect an evaporator and a compressor in a refrigerating cycle of a refrigerating device. That is, an evaporator tube forming the evaporator is usually made of aluminum, and a suction tube guiding a refrigerant to the compressor is usually made of copper. Thus, the aluminum tube and the copper tube, which are different in kinds of metal, should be joined so as to move the refrigerant passing through the evaporator to the compressor. Further, a method of joining the aluminum tube and the copper tube by heating and pressing with electricity and without soldering has been widely used in recent years.

Examples related to a technique of joining the aluminum tube and the copper tube are disclosed in U.S. Pat. No. 5,549,335 and Japanese First Publication No. 1975-134944.

In the method of joining an aluminum tube and a copper tube disclosed in U.S. Pat. No. 5,549,335, a contracted tubular part is formed by contracting one side of the copper tube, an expanded tubular part is formed by expanding one side of the aluminum tube, and the expanded tubular part of the aluminum tube and the contracted tubular part of the copper tube are then joined by heating and pressing. However, when such a joining method is used in a refrigerating cycle, there is a problem in that the diameter of the tube is contracted due to the contracted tubular part of the copper tube so that the efficiency of the refrigerating cycle is likely to be lowered.

In the method of joining an aluminum tube and a copper tube disclosed in Japanese First publication No. 1975-134944, a slant part is formed by machining one side of the copper tube, an expanded tubular part is formed by expanding one side of the aluminum tube, and the expanded tubular part of the aluminum tube and the slant part of the copper tube are joined by electrically heating and pressing. However, in the case where such a joining method is used in a refrigerating cycle, there is a problem in that a foreign matter such as an aluminum chip is produced in a joining process at a joint part and flows together with a refrigerant into a compressor so that the performance of the compressor is likely to be lowered.

### SUMMARY OF THE INVENTION

Accordingly, it is an aspect of the present invention to provide a dissimilar metal tube assembly and a method of assembling the same, wherein tubular contraction and foreign matter can be prevented from being produced at a joint area.

Additional aspects and/or advantages of the invention will be set forth in part in the description which follows and, in part, will be apparent from the description, or may be learned by practice of the invention.

The foregoing and/or other aspects of the present invention can be achieved by providing a dissimilar metal tube assembly, comprising: a first metal tube; a second metal tube having a melting point different from a melting point of the first metal tube; and a tubular sleeve connecting the first metal tube and the second metal tube to contact and couple with each other, opposite sides of the sleeve being coupled with the first metal tube and the second metal tube, respectively.

According to an aspect of the present invention, the sleeve comprises a first insertion part inserted into one side of the first metal tube while being contacted therewith; a second insertion part inserted into one side of the second metal tube while being contacted therewith; and a projection formed between the first and the second insertion parts such that the projection is located between the first and the second metal tubes.

According to an aspect of the present invention, the sleeve further comprises a cutting part formed in a longitudinal direction of the sleeve.

According to an aspect of the present invention, the projection is bent outward between the first insertion part and the second insertion part.

According to an aspect of the present invention, the projection is formed at a center area of the sleeve between the first and the second insertion parts.

According to an aspect of the present invention, the first metal tube comprises a slant part formed to have a decreasing outer diameter toward an end of the first metal tube.

According to an aspect of the present invention, the second metal tube comprises an expanded tubular part comprising a diameter which is expanded such that one side of the second metal tube is coupled with an outer circumference of the slant part of the first metal tube.

According to an aspect of the present invention, the first and the second metal tubes are joined by being heated and pressed in a state of being coupled with each other.

According to an aspect of the present invention, the first metal tube comprises a copper tube, and the second metal tube comprises an aluminum tube.

According to an aspect of the present invention, the sleeve comprises a metallic material having a melting point higher than the melting points of the first and the second metal tubes.

The foregoing and/or other aspects can also be achieved by providing a dissimilar metal tube assembly comprising: a first metal tube including a slant part formed to have a decreasing outer diameter toward an end side thereof; a second metal tube having a melting point different from a melting point of the first metal tube and including an expanded tubular part having a diameter which is expanded such that an end of the second metal tube is coupled with the outer diameter of the slant part of the first metal table; and a sleeve having opposite ends respectively inserted into the first and the second metal tubes while being contacted therewith in the state where the expanded tubular part of the second metal tube is coupled with the slant part of the first metal tube, and including a projection such that the sleeve is located between the first and the second metal tubes.

According to an aspect of the present invention, the first metal tube and the second metal tube are joined by being electrically heated and pressed when the first metal tube and the second metal tube are coupled with each other.

According to an aspect of the present invention, the first metal tube comprises a copper tube, the second metal tube comprises an aluminum tube, and the sleeve comprises a metallic material having a melting point higher that the melting points of the first and the second metal tubes.

The foregoing and/or other aspects of the present invention can also be achieved by providing a method of assembling a dissimilar metal tube assembly joining a first metal tube and a second metal tube, having different melting points, the method comprising: forming a slant part at an end of the first metal tube; forming an expanded tubular part having a diameter expanded at an end of the second metal tube corresponding to the slant part of the first metal tube; providing a tubular sleeve inserting opposite ends of the sleeve into the first and the second metal tubes, respectively; and heating and pressing the first and the second metal tubes to join the first and the second metal tubes to the sleeve.

According to an aspect of the present invention, the method further comprises forming a projection such that the sleeve is located between the first and the second metal tubes when the sleeve is inserted into the first and the second metal tubes while being contacted therewith.

According to an aspect of the present invention, the providing the sleeve comprises providing a sleeve made of a metallic material having a melting point higher than the melting points of the first and the second metal tubes.

According to an aspect of the present invention, the providing the sleeve comprises winding a metallic plate in the form of a tube.

According to an aspect of the present invention, the first metal tube comprises a copper tube, and the second metal tube comprises an aluminum tube.

### BRIEF DESCRIPTION OF THE DRAWINGS

The above and/or other aspects and advantages of the prevent invention will become apparent and more readily appreciated from the following description of the embodiments, taken in conjunction with the accompanying drawings, in which:

FIG. 1 is a cross-sectional view of a metal tube assembly according to an embodiment of the present invention;

FIG. 2 is an exploded perspective view of the metal tube assembly according to an embodiment of the present invention;

FIG. 3 is a perspective view of a sleeve in a metal tube assembly according to another embodiment of the present invention;

FIGS. 4 to 6 are views illustrating a process of assembling the metal tube assembly according to an embodiment of the present invention; and

FIG. 7 is a flowchart illustrating the process of assembling the metal tube assembly according to an embodiment present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Reference will now be made in detail to the embodiments of the present invention, examples of which are illustrated in the accompanying drawings, wherein like reference numerals refer to like elements throughout. The embodiments are described below so as to explain the present invention by referring to the figures.

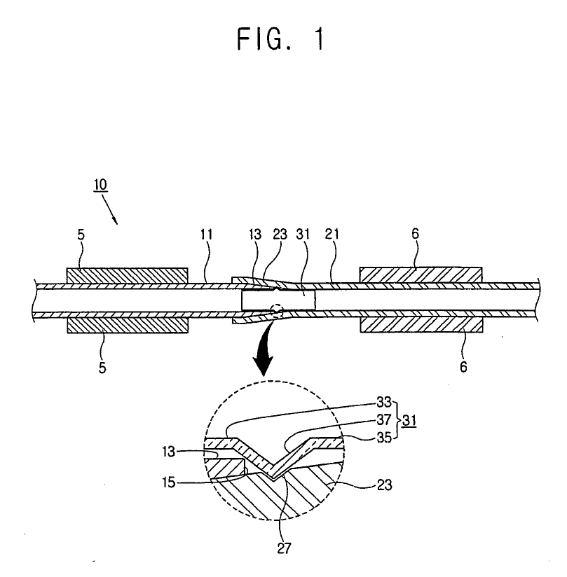

As shown in FIGS. 1 to 3, a dissimilar metal tube assembly 10 according to an embodiment of the present invention comprises a first metal tube 11, a second metal tube 21 having a melting point different from that of the first metal tube 11, and a tubular sleeve 31 connecting the first metal tube 11 and the second metal tube 21 such that they are contacted and joined while both sides of the sleeve 31 are coupled with the first metal tube 11 and the second metal tube 21, respectively. The dissimilar metal tube assembly 10 may be used to connect an evaporator and a compressor in a refrigerating cycle of a refrigerator, for example. That is, the dissimilar metal tube assembly 10 may be formed by the joint of an evaporator tube extended from the evaporator (not shown) and a suction tube connected to the compressor (not shown) in the refrigerating cycle.

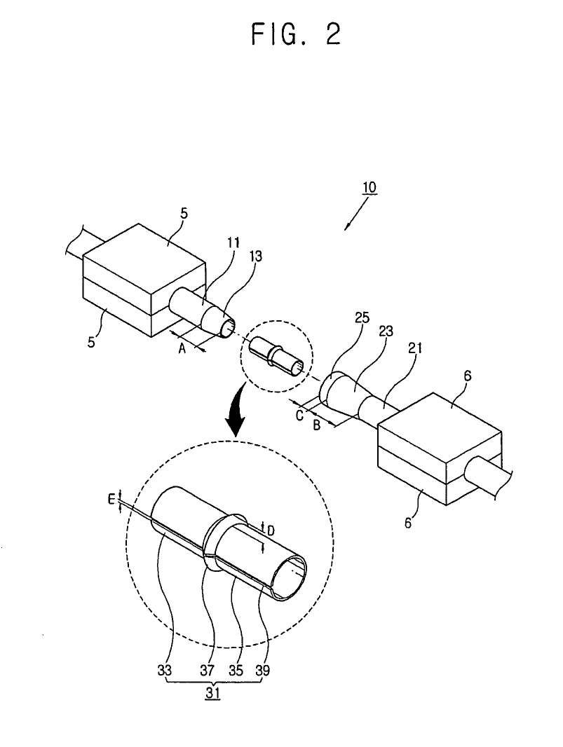

The first metal tube 11 is used as a suction tube connected to a compressor (not shown) such that a refrigerant discharged from an evaporator (not shown) is supplied to the compressor. The first metal tube 11 is made of a copper material, for example, and the melting point of the copper material is approximately 1000 degrees Celsius. The first metal tube 11 comprises a slant part 13 formed to be slanted toward the end 15 of one side of the first metal tube 11 coupled with the second metal tube 21. As shown in FIGS. 1 and 2, the first metal tube 11 is clamped and supported by a pair of first clamps 5. For example, the diameter of the first metal tube 11 is 8 mm, and the thickness thereof is 0.8 mm. However, it will be apparent that the diameter of the first metal tube 11 may vary, also being 10 mm, 6 mm or the like, and the thickness thereof may vary, also being 1.0 mm, 0.6 mm or the like.

For purposes of discussion, the first metal tube 11 has a diameter of 8 mm and a thickness of 0.8 mm.

The slant part 13 is machined to be slanted toward the end 15 of one side of the first metal tube 11 coupled with the second metal tube 21 by a cutting device such as a lathe. As shown in FIG. 2, the length A of the slant part 13 may be about 5 mm to 6 mm in the case where the diameter of the first metal tube 11 is 8 mm, and the thickness thereof is 0.8 mm, for example. However, it will be apparent that the length A of the slant part 13 may be larger than 6 mm or smaller than 5 mm depending on the diameter and thickness of the first metal tube 11. For example, the thickness of the end 15 of the slant part 13 is about 0.2 mm when the diameter of the first metal tube 11 is 8 mm and the thickness thereof is 0.8 mm, but may vary depending on the length A of the slant part 13, the thickness of the first metal tube 11 or the like.

The second metal tube 21 is formed to be extended from a refrigerant tube of an evaporator. The second metal tube 21 is made of an aluminum material, for example, and the melting point of the aluminum material is approximately 670 degrees Celsius. The second metal tube 21 comprises an expanded tubular part 23 formed to be slanted in a direction of the end of one side of the second metal tube 21 coupled with the slant part 13 of the second metal tube 11. As shown in FIGS. 1 and 2, the second metal tube 21 is clamped and supported by a pair of second clamps 6. The diameter of the second metal tube 21 is 8 mm, and the thickness thereof is 1.0 mm. However, it will be apparent that the diameter of the second metal tube 21 may vary, to be 10 mm, 6 mm or the like, and the thickness thereof may vary, to be 1.2 mm, 0.8 mm or the like.

For purposes of discussion, the second metal tube 21 has a diameter of 10 mm, and a thickness of 1.0 mm.

The expanded tubular part 23 is formed such that the diameter of one side of the second metal tube 21 is expanded to be in contact with the outer circumferential surface of the slant part 13 while housing the slant part 13. As shown in FIG. 2, the length B of the expanded tubular part 23 may be about 9 mm to 10 mm to be larger than the length A of the slant part 13 in the case where the diameter of the second metal tube 21 is 8 mm and the thickness thereof is 1.0 mm, for example. However, the length B of the expanded tubular part 23 may vary depending on the length A of the slant part 13 or the like. Further, an extension part 25 is formed at the end of the expanded tubular part 23 such that the extension part 25 can house and contact the outer circumferential surface of the first metal tube 11 connected with the slant part 13. For example, the length C of the extension part 25 is about 2.0 mm in the case where the diameter of the second metal tube 21 is 8 mm and the thickness thereof is 1.0 mm, but may vary depending on the length A of the slant part 13 or the like.

The sleeve 31 comprises a first insertion part 33 inserted into one side of the first metal tube 11 while being contacted therewith, a second insertion part 35 inserted into one side of the second metal tube 21 while being contacted therewith, and a projection 37 formed between the first and the second insertion parts 33 and 35 such that the projection 37 can be located between the first metal tube 11 and the second metal tube 21. The sleeve 31 may further comprise a cutting part 39 formed in a longitudinal direction of the sleeve 31. The sleeve 31 may be made of a metallic material having a melting point higher than those of the first and the second metal tubes 11 and 21. For example, the sleeve 31 is made of stainless steel of which the melting point is approximately 1400 degrees Celsius. However, the sleeve 31 may be made of various metallic materials such as molybdenum steel with a melting point higher than those of the first and the second metal tubes 11 and 21. For example, the diameter, the thickness and the length of the sleeve 31 are respectively about 6 mm, about 0.1 mm and about 20 mm such that the sleeve 31 is inserted into the first metal tube 11 and the second metal tube 21. However, the sleeve 31 may be formed with a variety of dimensions such that the sleeve 31 is inserted into the first metal tube 11 and the second metal tube 21.

The first insertion part 33 is formed in a shape of a tube and inserted into one side of the first metal tube 11, at which the slant part 13 is formed. The diameter of the first insertion part 33 may be almost the same as that of the inner circumference of the first metal tube 11 such that the first insertion part 33 can be adhere closely to the inner surface of the one side of the first metal tube 11.

The second insertion part 35 is formed in the shape of a tube, like the first insertion part 33, and is inserted into the inner surface of the second metal tube 21 connected with the expanded tubular part 23. The diameter of the second insertion part 35 may be almost the same as that of the inner circumference of the second metal tube 21 such that the second insertion part 35 can adhere closely to the inner surface of the one side of the second metal tube 21.

As shown in FIGS. 1 and 2, the projection 37 may be bent outward between the first insertion part 33 and the second insertion part 35. For example, the projection 37 is protruded outward in the form of a triangle between the first insertion part 33 and the second insertion part 35. Thus, as shown in FIG. 1, the projection 37 is located between the end of one side of the first metal tube 11 and the inner surface at which the expanded tubular part 23 is started from one side of the second metal tube 21 in the state where the expanded tubular part 23 of the second metal tube 21 is coupled to contact the slant part 13 of the first metal tube 11. As shown in FIG. 2, the height D of the projection 37 is about 0.5 mm, for example. However, the height D of the projection 37 may be formed to be larger than that of the end 15 of the first metal tube 11 with a variety of dimensions such as 0.3 mm or 0.7 mm.

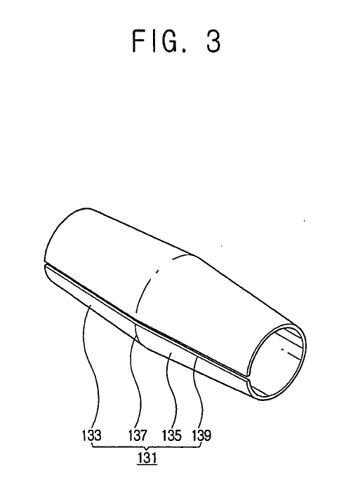

FIG. 3 illustrates another embodiment of a sleeve 131. The sleeve 131 comprises a first insertion part 133 inserted into one side of the first metal tube 11 while being contacted therewith, a second insertion part 135 inserted into one side of the second metal tube 21 while being contacted therewith, a projection 137 located between the first and the second insertion parts 133 and 135 such that the projection 137 can be located between the first metal tube 11 and the second metal tube 21, and a cutting part 139 formed in a longitudinal direction of the sleeve 131. However, unlike the embodiment of FIG. 2, the projection 137 is formed such that each of the first and the second insertion parts 133 and 135 is protruded outward from the end toward the center thereof.

In the case where a predetermined plate-shaped material is circularly wound so as to manufacture the sleeve 31, the cutting part 39 is formed by both ends of the plate-shaped material, which are spaced apart from each other. The cutting part 39 is formed in a direction where the sleeve 31 is inserted into the first metal tube 11 and the second metal tube 21. Both the ends of the cutting part 39 are formed to be spaced apart, leaving a predetermined gap such that the first and the second insertion parts 33 and 35 can be respectively inserted into the first and the second metal tubes 11 and 12 by contracting the first and the second insertion parts 33 and 35. Through the cutting part 39, the first insertion part 33 and the second insertion part 35 can be inserted into the first metal tube 11 and the second metal tube 21 with a predetermined elastic force, respectively. The width E of the cutting part 39 is about 0.4 mm, for example, but may vary to be 0.2 mm, 0.6 mm or the like.

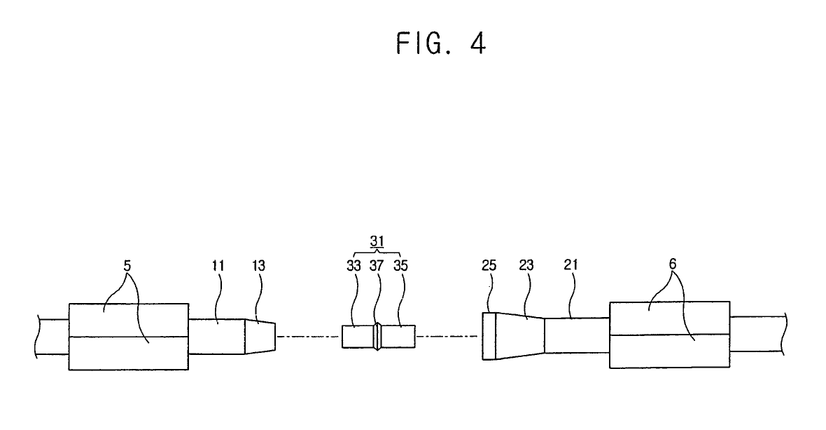

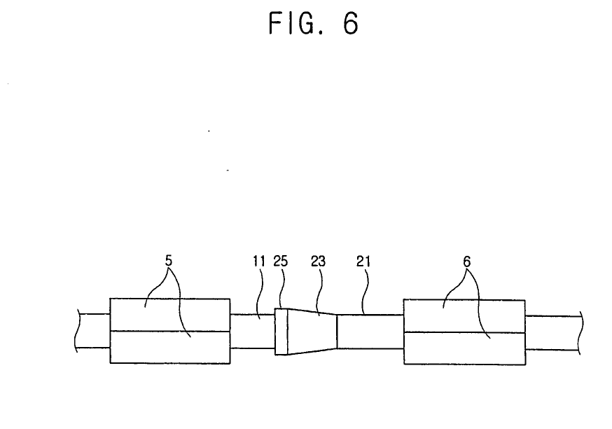

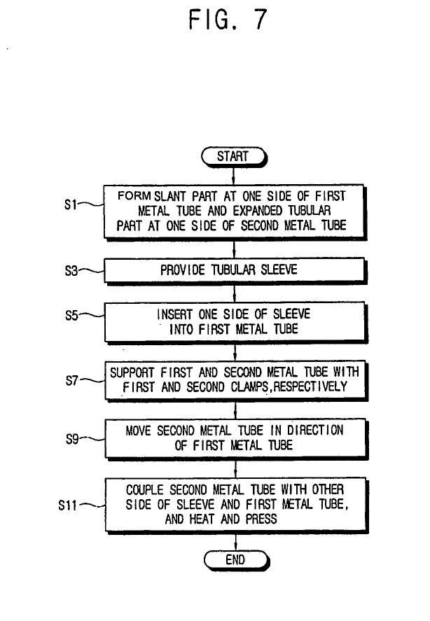

A process of assembling a metal tube assembly according to the embodiments of the present invention will be described below with reference to FIGS. 4 to 7.

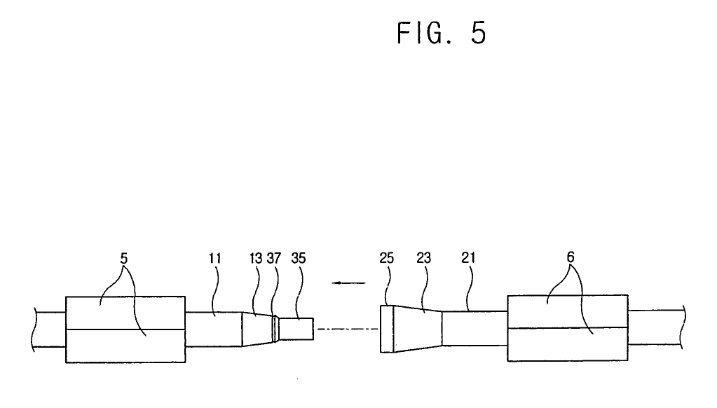

First, the slant part 13 is formed at one side of the first metal tube 11 using a lathe or the like, and the expanded tubular part 23 is formed at one side of the second metal tube 21 at operation S1. Further, the tubular sleeve 31 is provided such that it can be inserted into the first metal tube 11 and the second metal tube 21 at operation S3. Then, as shown in FIG. 4, the pair of first clamps 5 moves to support the first metal tube 11 having the slant part 13 formed at the one side thereof, and the pair of first clamps 6 moves to support the second metal tube 21 having the expanded tubular part 23 formed at the one side thereof at operation S5. Further, as shown in FIG. 5, a first insertion part 33 formed at one side of the sleeve 31 is inserted into the first metal tube 11 at operation S7, and the second metal tube 21 is moved to a direction of the first metal tube 11 by the second clamps 6 at operation S9. Then, the second metal tube 21 is pressed to be coupled with the other side of the sleeve 31 and the first metal tube 11, and the first and the second metal tubes 11 and 21 are heated by applying electricity thereto via the first and the second clamps 5 and 6 at operation S11. That is, the first and the second metal tubes 11 and 21 are electrically heated, and the slant 13 of the first metal tube 11 and the expanded tubular part 23 of the second metal tube 21 are pressed to contact with each other, so that the first and the second metal tubes 11 and 21 are joined. At this time, the eutectic temperature of the first and the second metal tubes 11 and 21, which is the heating temperature thereof, is about 540 to 550 degrees Celsius, for example. However, the first and the second metal tubes 11 and 21 may be heated at a variety of temperatures as long as it is lower than the melting point of aluminum.

Thus, a heat affected zone is formed at an area where the first metal tube 11 and the second metal tube 21 are contacted by heating to the eutectic temperature so that the first metal tube 11 and the second metal tube 21 are joined with each other. However, since the sleeve 31 has a melting point considerably higher than the eutectic temperature, the mechanical strength and the corrosion resistance thereof can be maintained even at such an eutectic temperature. Further, since the second metal tube 21 becomes soft as the second metal tube 21 is heated at the eutectic temperature, the projection 37 of the sleeve 31 forms a projection housing part 27 on the inner surface of the expanded tubular part 23 as shown in FIG. 1. Accordingly, the sleeve 31 is located inside an area where the heat affected zone is formed so that the sleeve 31 can prevent foreign matter such as an aluminum chip, which may be produced from the heat affected zone, from being mixed with a refrigerant. That is, the foreign matter such as the aluminum chip, which may be produced from the heat affected zone, does not pass through a space between the projection 37 of the sleeve 31 and the projection housing part 27 of the second metal tube 21 and between the first insertion part 33 of the sleeve 31 and the first metal tube 11, so that the foreign matter can be prevented from flowing together with the refrigerant.

Further, since the thickness of the sleeve 31 is about 0.1 mm, the sleeve 31 has no effect on the flow of the refrigerant so that the efficiency of a refrigerating cycle can be prevented from being lowered.

As described above, there is a dissimilar metal tube assembly and a method of assembling the same, wherein the efficiency of a refrigerating cycle can be prevented from being lowered, and foreign matter can be prevented from being produced.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A dissimilar metal tube assembly, comprising:
a first metal tube;
a second metal tube having a melting point different from a melting point of the first metal tube; and
a tubular sleeve connecting the first metal tube and the second metal tube to contact and couple with each other, opposite sides of the sleeve being coupled with the first metal tube and the second metal tube, respectively.

2. The dissimilar metal tube assembly according to claim 1, wherein the sleeve comprises:
a first insertion part inserted into one side of the first metal tube while being contacted therewith;
a second insertion part inserted into one side of the second metal tube while being contacted therewith; and
a projection formed between the first and the second insertion parts such that the projection is located between the first and the second metal tubes.

3. The dissimilar metal tube assembly according to claim 2, wherein the sleeve further comprises a cutting part formed in a longitudinal direction of the sleeve.

4. The dissimilar metal tube assembly according to claim 2, wherein the projection is bent outward between the first insertion part and the second insertion part.

5. The dissimilar metal tube assembly according to claim 3, wherein the projection is formed at a center area of the sleeve between the first and the second insertion parts.

6. The dissimilar metal tube assembly according to claim 1, wherein the first metal tube comprises a slant part formed to have an outer diameter decreasing toward an end of the first metal tube.

7. The dissimilar metal tube assembly according to claim 6, wherein the second metal tube comprises an expanded tubular part comprising a diameter which is expanded such that one side of the second metal tube is coupled with an outer circumference of the slant part of the first metal tube.

8. The dissimilar metal tube assembly according to claim 2, wherein the first metal tube comprises a slant part having an outer diameter decreasing toward an end of one side of the first metal tube.

9. The dissimilar metal tube assembly according to claim 8, wherein the second metal tube comprises an expanded tubular part comprising a diameter which is expanded such that the one side of the second metal tube is coupled with an outer circumference of the slant part of the first metal tube.

10. The dissimilar metal tube assembly according to claim 1, wherein the first and the second metal tubes are joined by being heated and pressed in a state of being coupled with each other.

11. The dissimilar metal tube assembly according to claim 10, wherein the first metal tube comprises a copper tube, and the second metal tube comprises an aluminum tube.

12. The dissimilar metal tube assembly according to claim 10, wherein the sleeve comprises a metallic material having a melting point higher than the melting points of the first and the second metal tubes.

13. A dissimilar metal tube assembly, comprising:
a first metal tube including a slant part formed to have a decreasing outer diameter toward an end thereof;
a second metal tube having a melting point different from a melting point of the first metal tube and including an expanded tubular part having a diameter which is expanded such that an end of the second metal tube is coupled with the outer diameter of the slant part of the first metal tube; and
a sleeve having opposite ends respectively inserted into the first and the second metal tubes while being contacted therewith in the state where the expanded tubular part of the second metal tube is coupled with the slant part of the first metal tube, and including a projection such that the sleeve is located between the first and the second metal tubes.

14. The dissimilar metal tube assembly according to claim 13, wherein the first metal tube and the second metal tube are joined by being electrically heated and pressed when the first metal tube and the second metal tube are coupled with each other.

15. The dissimilar metal tube assembly according to claim 13, wherein the first metal tube comprises a copper tube, the second metal tube comprises an aluminum tube, and the sleeve comprises a metallic material having a melting point higher that the melting points of the first and the second metal tubes.

16. A method of assembling a dissimilar metal tube assembly joining a first metal tube and a second metal tube, having different melting points, the method comprising:
forming a slant part at an end of the first metal tube;
forming an expanded tubular part having a diameter expanded at an end of the second metal tube corresponding to the slant part of the first metal tube;
providing a tubular sleeve;
inserting opposite ends of the sleeve into the first and the second metal tubes, respectively; and
heating and pressing the first and the second metal tubes to join the first and the second metal tubes to the sleeve.

17. The method according to claim 16, further comprising forming a projection such that the sleeve is located between the first and the second metal tubes when the sleeve is inserted into the first and the second metal tubes while being contacted therewith.

18. The method according to claim 16, wherein the providing the sleeve comprises providing a metallic material having a melting point higher than the melting points of the first and the second metal tubes.

19. The method according to claim 18, the providing the sleeve comprises winding a metallic plate in the form of a tube.

20. The method according to claim 16, wherein the first metal tube comprises a copper tube, and the second metal tube comprises an aluminum tube.

21. A dissimilar metal tube assembly, comprising:
providing a first metal tube;
providing a second metal tube having a melting point different from a melting point of the first metal tube; and
connecting the first metal tube and the second metal tube with a tubular sleeve, opposite sides of the sleeve being coupled with the first metal tube and the second metal tube, respectively.
